(19) United States
(12) Patent Application Publication
(10) Pub. No.: US 2025/0095890 A1
(43) Pub. Date: Mar. 20, 2025

(54) SURGE PROTECTION DEVICES INCLUDING VARISTORS

(71) Applicant: RAYCAP IP DEVELOPMENT LTD, Strovolos (CY)

(72) Inventors: Antony J. Surtees, Chagrin Falls, OH (US); Jacob Andersen, Cataldo, ID (US); Brian J. Chamberlin, Coeur d’Alene, ID (US); Marko Tomšic, Ljubljana (SI); James A. Wilson, Coeur d’Alene, ID (US)

(21) Appl. No.: 18/792,886

(22) Filed: Aug. 2, 2024

Related U.S. Application Data
(63) Continuation-in-part of application No. 18/468,766, filed on Sep. 18, 2023.

(51) Int. Cl. H01C 7/12; H01C 1/14

(52) U.S. Cl. CPC H01C 7/126; H01C 1/14

(57) ABSTRACT

A surge protective device (SPD) module includes first, second and third terminals, a node connected to the third terminal, a varistor stack, a first branch, and a second branch. The varistor stack assembly includes a first varistor, a second varistor, and a node electrode interposed between the first and second varistors. The node electrode is electrically connected to the first and second varistors and includes the node. The first branch includes the first varistor connected between the first terminal and the node, and a first thermal disconnector mechanism configured to disconnect the first varistor from the first terminal or the node. The second branch includes the second varistor connected between the second terminal and the node, and a second thermal disconnector mechanism configured to disconnect the second varistor from the second terminal or the node.

### RELATED APPLICATION(S)

The present application is a continuation-in-part of and claims priority from U.S. patent application Ser. No. 18/468,766, filed on Sep. 18, 2023, the entire content of which is incorporated by reference herein.

### FIELD

The present inventive concepts relate generally to surge protection devices and, more particularly, to surge protection device modules.

### BACKGROUND

A varistor, short for “variable resistor,” is an electronic component used to protect other electronic components from voltage surges. A varistor is made of a semiconductor material, typically zinc oxide, which has a highly nonlinear voltage-current (V/I) characteristic. When the voltage across the varistor is below a certain threshold, it presents a very high impedance, acting almost like an open circuit. But when the voltage exceeds this threshold, the impedance drops significantly, allowing current to flow through it. When a voltage surge or transient occurs, the varistor quickly becomes conductive, providing a low-impedance path for the excess current thereby providing protection to sensitive electronic loads. This effectively clamps the voltage to a safe level and protects the circuit from damage. Varistors are commonly used in power supplies, surge protectors, and electronic equipment to protect against lightning strikes, electrostatic discharge, and other voltage surges that can damage or destroy sensitive components. They are also used in electronic circuits to stabilize voltage levels and reduce noise. Overall, a varistor is a simple but effective component that often plays a crucial role in protecting electronic equipment from damage caused by voltage surges.

Varistors may be constructed to have different designs for different applications. For industrial applications (surge protective devices (SPDs) containing a number of, leaded varistors arrayed together to total surge ratings ranging from 30 kA up to as much as 500 kA per phase are often used. A leaded varistor typically includes a disk-shaped varistor element with conductive leads connected on either end of the varistor and coated in an insulating material, such as epoxy. The varistor disk is formed by pressure casting and sintering a metal oxide material, such as silicon carbide, zinc oxide, or other suitable material. Electrically conductive material may be screen printed on the opposing surfaces of the disk. Shaped electrodes may be bonded to the two conductive surfaces and the disk and electrode assembly may be encapsulated with an insulating material. The above varistor construction may also make use of a thermal disconnector, where the current and associated heat generated during a voltage increase is used to disconnect the individual varistors before a fire hazard results.

The above-described varistor construction, however, may perform inadequately due to the inability to withstand sufficiently high currents during a surge event. As a result, multiple varistor wafers may be mounted on a PCB in such a way as to create a parallel array to increase the surge current withstand capacity. However, during high surge currents, some of the varistor disks may prematurely fail due to an uneven sharing of the current between the individual varistor wafers in the parallel array caused by tolerance differences in the electrical characteristics. More specifically, this lack of matching may lead to premature thermal runaway due to an imbalance in the current flow through each varistor in the parallel array.

### SUMMARY

According to some embodiments of the inventive concept, a surge protection device (SPD) module, comprises: a housing; a plurality of metal oxide varistor (MOV) wafers, respective ones of the plurality of MOV wafers having electrical characteristics that reduce an imbalance in current between the respective ones of the plurality of MOV wafers in response to an overvoltage event; and one or more electrodes, the plurality of MOV wafers and the one or more electrodes being alternately arranged in the housing.

In other embodiments, at least one of the MOV wafers has a different clamping voltage than another one of the MOV wafers.

In still other embodiments, at least one of the MOV wafers has a different thickness than another one of the MOV wafers.

In still other embodiments, at least one of the MOV wafers has a different material composition than another one of the MOV wafers.

In still other embodiments, at least one of the MOV wafers comprises zinc oxide or silicon carbide.

In still other embodiments, at least one of the MOV wafers has a different grain size than another one of the MOV wafers.

In still other embodiments, at least one of the MOV wafers has a different impurity doping than another one of the MOV wafers.

In still other embodiments, a first manufacturing process used to make at least one of the MOV wafers is different than a second manufacturing process used to make at least another one of the MOV wafers.

In still other embodiments, the first manufacturing process and the second manufacturing process differ in temperature or pressure.

In still other embodiments, one of the one or more electrodes includes a tab portion that is configured to extend outside the housing and is further configured to attach to a disconnector element via a conductive thermal adhesive material; and the conductive thermal adhesive material is configured to soften in response to heat applied thereto causing the tab portion to separate from the disconnector element.

In still other embodiments, a first one of the one or more electrodes includes a first tab portion configured to connect to a first connection port; and a second one of the one or more electrodes includes a second tab portion configured to connect to a second connection port.

In still other embodiments, the housing comprises an insulating material.

In still other embodiments, the insulating material is epoxy.

In some embodiments of the inventive concept, a surge protection device (SPD) assembly comprises: a base; and an SPD mounted on the base, the SPD comprising: a housing; a plurality of metal oxide varistor (MOV) wafers, respective ones of the plurality of MOV wafers having electrical characteristics that reduce an imbalance in current between the respective ones of the plurality of MOV wafers in response to an overvoltage event; and one or more electrodes, the plurality of MOV wafers and the one or more electrodes being alternately arranged in the housing.

In further embodiments, the SPD assembly further comprises: a disconnector element mounted on the base and configured to receive the overvoltage event; wherein one of the one or more electrodes includes a tab portion that is configured to extend outside the housing and is further configured to attach to the disconnector element via a conductive thermal adhesive material; and wherein the conductive thermal adhesive material is configured to soften in response to heat applied thereto causing the tab portion to separate from the disconnector element.

In further embodiments, the SPD assembly further comprises: an alert circuit mounted on the base and configured to generate an alert signal when the tab portion separates from the disconnector element.

In still further embodiments, the alert circuit includes an optical generator that is configured to generate an optical beam and an optical detection circuit that is configured to detect the optical beam; and the disconnector element includes a beam splitter tab that is configured to block the optical beam from the optical detection circuit when the disconnector element is attached to the tab portion.

In still further embodiments, the disconnector element is biased to remove the beam splitter tab from between the optical generator and the optical detection circuit responsive to the disconnector element separating from the disconnector element; and the optical detection circuit is further configured to generate the alert signal responsive to detection of the optical beam.

In still further embodiments, a first one of the one or more electrodes includes a first tab portion configured to connect to a first connection port; and a second one of the one or more electrodes includes a second tab portion configured to connect to a second connection port.

In still further embodiments, the base is a printed circuit board.

According to some embodiments, a surge protective device (SPD) module includes first, second and third terminals, a node connected to the third terminal, a varistor stack, a first branch, and a second branch. The varistor stack assembly includes a first varistor, a second varistor, and a node electrode interposed between the first and second varistors. The node electrode is electrically connected to the first and second varistors and includes the node. The first branch includes the first varistor connected between the first terminal and the node, and a first thermal disconnector mechanism configured to disconnect the first varistor from the first terminal or the node. The second branch includes the second varistor connected between the second terminal and the node, and a second thermal disconnector mechanism configured to disconnect the second varistor from the second terminal or the node.

In some embodiments, the node electrode has opposed first and second varistor contact surfaces, the first varistor contact surface engages the first varistor, and the second varistor contact surface engages the second varistor.

According to some embodiments, the first thermal disconnector mechanism includes: a first disconnect arm electrically connected to the first varistor; and a spring-loaded, electrically insulating first barrier member configured to electrically isolate the first disconnect arm from the first varistor when the first thermal disconnector mechanism is actuated; and the second thermal disconnector mechanism includes: a second disconnect arm electrically connected to the second varistor; and a spring-loaded, electrically insulating second barrier member configured to electrically isolate the second disconnect arm from the second varistor when the second thermal disconnector mechanism is actuated.

In some embodiments, the first thermal disconnector mechanism includes a first solder connection including a first solder that retains the first disconnect arm in electrical connection with the first varistor. When the first solder melts and releases the first disconnect arm, the first barrier member is thereby permitted to move from a ready position to a disconnect position in which the first barrier member electrically isolates the first disconnect arm from the first varistor. The second thermal disconnector mechanism includes a second solder connection including a second solder that retains the second disconnect arm in electrical connection with the second varistor. When the second solder melts and releases the second disconnect arm, the second barrier member is thereby permitted to move from a ready position to a disconnect position in which the second barrier member electrically isolates the second disconnect arm from the second varistor.

In some embodiments, the varistor stack assembly further includes a first contact electrode on a side of the first varistor opposite the node electrode, and a second contact electrode on a side of the second varistor opposite the node electrode. The first solder releasably affixes the first disconnect arm to the first contact electrode. The second solder releasably affixes the second disconnect arm to the second contact electrode.

According to some embodiments, the SPD module includes an integral first signalization switch to indicate failure of the first varistor. The first thermal disconnector mechanism is configured such that the first barrier member actuates the first signalization switch when the first thermal disconnector mechanism is actuated. The SPD module includes an integral second signalization switch to indicate failure of the second varistor. The second thermal disconnector mechanism is configured such that the second barrier member actuates the second signalization switch when the second thermal disconnector mechanism is actuated.

According to some embodiments, the SPD module includes an integral first signalization switch to indicate failure of the first varistor. The SPD module includes an integral second signalization switch to indicate failure of the second varistor. The first thermal disconnector mechanism is configured to actuate an external first signalization switch using the first barrier member when the first thermal disconnector mechanism is actuated. The second thermal disconnector mechanism is configured to actuate an external second signalization switch using the second barrier member when the second thermal disconnector mechanism is actuated.

According to some embodiments, a surge protective device (SPD) unit includes a printed circuit board (PCB) assembly and an SPD module. The PCB assembly includes a PCB including PCB contacts. The SPD module is mounted on the PCB and includes first, second and third terminals, a node connected to the third terminal, a varistor stack assembly, a first branch, and a second branch. The first, second and third terminals electrically engage the PCB contacts to connect the SPD module to the PCB assembly. The varistor stack assembly includes a first varistor, a second varistor, and a node electrode interposed between the first and second varistors. The node electrode is electrically connected to the first and second varistors and includes the node. The first branch includes the first varistor connected between the first terminal and the node, and a first thermal disconnector mechanism configured to disconnect the first varistor from the first terminal or the node. The second branch includes the second varistor connected between the second terminal and the node, and a second thermal disconnector mechanism configured to disconnect the second varistor from the second terminal or the node.

According to some embodiments, a surge protective device (SPD) module includes a varistor stack assembly including a first varistor and a second varistor electrically connected to a first terminal and a second terminal, respectively, the first varistor and second varistor being further electrically connected to each other at a third terminal, the first varistor and the second varistor having electrical characteristics that reduce an imbalance in current between the first varistor and the second varistor in response to an overvoltage event. The first, second, and third terminals are configured to electrically connect the varistor stack assembly between one or more pairs of a plurality of lines.

In some embodiments, the plurality of lines includes a plurality of power lines and a ground line, the first and second terminals are electrically connected to each other to form a common terminal, and the common terminal and the third terminal are configured to electrically connect the varistor stack assembly between one of the plurality of power lines and the ground line.

In some embodiments, the plurality of lines includes a plurality of power lines and a neutral line, the first and second terminals are electrically connected to each other to form a common terminal, and the common terminal and the third terminal are configured to electrically connect the varistor stack assembly between one of the plurality of power lines and the neutral line.

In some embodiments, the plurality of lines includes a plurality of power lines, a ground line, and a neutral line, and the third terminal is configured to electrically connect the first and second varistors to one of the plurality of power lines, the first terminal is configured to electrically connect the first varistor to the neutral line, and the second terminal is configured to electrically connect the second varistor to the ground line.

In some embodiments, the plurality of lines includes a plurality of power lines, and the third terminal is configured to electrically connect the first and second varistors to a first one of the plurality of power lines, the first terminal is configured to electrically connect the first varistor to a second one of the plurality of power lines, and the second terminal is configured to electrically connect the second varistor to a third one of the plurality of power lines.

In some embodiments, the plurality of lines includes a plurality of power lines and a ground line, and the third terminal is configured to electrically connect the first and second varistors to a first one of the plurality of power lines, the first terminal is configured to electrically connect the first varistor to a second one of the plurality of power lines, and the second terminal is configured to electrically connect the second varistor to the ground line.

In some embodiments, the plurality of lines includes a plurality of power lines and a neutral line, and the third terminal is configured to electrically connect the first and second varistors to a first one of the plurality of power lines, the first terminal is configured to electrically connect the first varistor to a second one of the plurality of power lines, and the second terminal is configured to electrically connect the second varistor to the neutral line.

In some embodiments, the plurality of lines include a plurality of power lines, and the plurality of power lines include power lines in a single phase power system or phase lines in a multiple phase power system.

According to some embodiments, the first varistor has a different clamping voltage than the second varistor, the first varistor has a different thickness than the second varistor, the first varistor has a different material composition than the second varistor, the first varistor has a different grain size than the second varistor, or the first varistor has a different grain size than the second varistor.

Other methods, systems, apparatus and/or articles of manufacture according to embodiments of the inventive concept will be or become apparent to one with skill in the art upon review of the following drawings and detailed description. It is intended that all such additional methods, systems, apparatus and/or articles of manufacture be included within this description, be within the scope of the present inventive concept and be protected by the accompanying claims.

### BRIEF DESCRIPTION OF THE DRAWINGS

Other features of embodiments will be more readily understood from the following detailed description of specific embodiments thereof when read in conjunction with the accompanying drawings, in which:

FIG. 1A is a perspective view metal oxide varistor (MOV) wafer stack for use in a surge protection device in accordance with some embodiments of the inventive concept;

FIG. 1B is an exploded perspective view of the MOV stack of FIG. 1A;

FIG. 1C is a perspective view of the MOV stack of FIG. 1A enclosed in a housing to form the surge protection device in accordance with some embodiments of the inventive concept;

FIG. 2 is a perspective view of a MOV stack for use in a surge protection device in which the MOV wafers have different thicknesses in accordance with some embodiments of the inventive concept;

FIG. 3A is a perspective view of two MOV stacks mounted on a base each with disconnector elements in a connected position attached thereto in accordance with some embodiments of the inventive concept;

FIG. 3B is a perspective view of two MOV stacks mounted on a base each with disconnector elements in a disconnected position in accordance with some embodiments of the inventive concept;

FIG. 4 is a perspective view of two MOV stacks mounted on a base with each MOV stack coupled to two connection ports;

FIG. 5 is a perspective view of an MOV stack with two disconnector elements in a connected position and including beam splitter tabs, respectively, in accordance with some embodiments of the inventive concept;

FIG. 6A is a circuit diagram of an alert circuit in which the disconnector element is in a connected position in accordance with some embodiments of the inventive concept; and

FIG. 6B is a circuit diagram of the alert circuit of FIG. 6A in which the disconnector element is in a disconnected position in accordance with some embodiments of the inventive concept.

FIG. 7 is a schematic electrical diagram illustrating a power supply circuit including a SPD unit according to some embodiments.

FIG. 8 is a schematic electrical diagram illustrating an SPD module electrical circuit according to some embodiments and forming a part of the SPD unit of FIG. 7.

FIG. 9 is a perspective view of the SPD unit of FIG. 7.

FIG. 10 is a fragmentary, perspective view of an SPD module forming a part of the SPD unit of FIG. 7.

FIG. 11 is a fragmentary, perspective view of the SPD module of FIG. 10.

FIG. 12 is an exploded, fragmentary, perspective view of the SPD module of FIG. 10.

FIG. 13 is a perspective view of a varistor stack assembly of the SPD module of FIG. 10.

FIG. 14 is an exploded, perspective view of the varistor stack assembly of FIG. 13.

FIG. 15 is a cross-sectional view of the SPD module of FIG. 10 taken along the line 15-15 of FIG. 11.

FIG. 16 is a schematic electrical diagram illustrating the SPD module of FIG. 10 installed in a common mode overvoltage protection configuration.

FIG. 17 is a perspective view of an SPD unit according to further embodiments.

FIG. 18 is a fragmentary, perspective view of the SPD unit of FIG. 17.

FIGS. 19-21 are example circuit block diagrams of the SPD module of FIG. 7 arranged in different single mode configurations.

FIGS. 22-25 are example circuit block diagrams of the SPD module of FIG. 7 arranged in different multi-mode configurations.

### DETAILED DESCRIPTION

In the following detailed description, numerous specific details are set forth to provide a thorough understanding of embodiments of the inventive concept. However, it will be understood by those skilled in the art that embodiments of the inventive concept may be practiced without these specific details. In some instances, well-known methods, procedures, components, and circuits have not been described in detail so as not to obscure the inventive concept. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

Some embodiments of the inventive concept stem from a realization that single metal oxide varistors (MOVs) used in surge protection devices are often inadequate to withstand the current that may be generated during an overvoltage event. As a result, multiple MOVs may be placed in parallel with each other to increase the current carrying capacity of a surge protection device or assembly (module). Because there may not be any coordination between the electrical characteristics of the MOVs in the parallel array, one or more of the MOVs may fail due to premature thermal runaway due to an imbalance in current flowing through the individual MOVs. Some embodiments of the inventive concept may provide a surge protection device (SPD) module that includes multiple MOV wafers that respectively have electrical characteristics that reduce an imbalance in current between the different MOV wafers. This may improve the isothermal characteristics of the individual MOV wafers during an overvoltage event. Specifically, by reducing an imbalance in current flow between the varistor wafers, the current flow and resulting heat may be spread across the entire stack of MOV wafers that make up the SPD assembly (module) in a more spatially isothermal manner or more spatially uniform manner, reducing the likelihood that one or more of the MOV wafers may fail. As a result, the current carrying capacity of the SPD in response to an overvoltage event is increased. One or more disconnector elements may be used to couple one or more MOV wafers to a terminal that may be connected to an overvoltage event. An electrically conductive thermal adhesive, such as solder, that may be configured to soften in response to heat may be used to couple a disconnector element to an MOV wafer to protect the SPD if a surge event causes such an increase in current that an associated isothermal temperature rise may damage the SPD assembly. When the conductive thermal solder softens, the disconnector element may separate from the MOV thereby disconnecting the MOV from the source of the overvoltage event. The disconnection may be due to the shared heat generated across the stack of MOV wafers included in the SPD assembly.

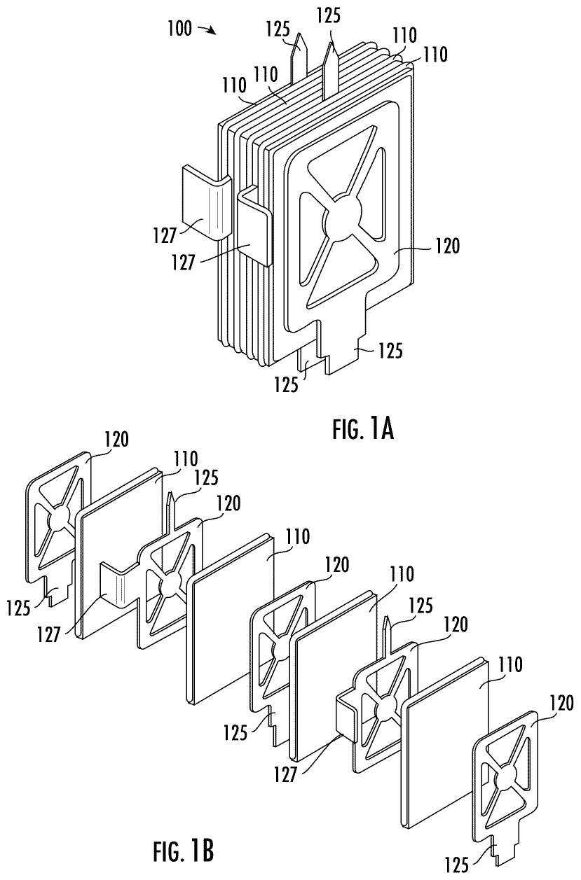

FIG. 1A is a perspective view metal oxide varistor (MOV) stack for use in a surge protection device in accordance with some embodiments of the inventive concept. FIG. 1B is an exploded perspective view of the MOV stack of FIG. 1A. As shown in FIGS. 1A and 1B, an MOV stack 100 includes a plurality of MOV wafers 110 that are alternately arranged with parallelization electrodes 120 to form the varistor stack. Each of the conductive electrodes 120 may include one or more electrodes 125 and 127 that may be used for various purposes mechanical and/or electrical disconnection, printed circuit board (PCB) mounting, alignment, and/or electrical connection between the conductive electrodes. The electrodes 127 may, in some embodiments, be used as a tab for connection to a disconnector element to disconnect the varistor stack 100 from a source of an overvoltage event to protect the varistor stack 100 from thermal damage. FIG. 1C is a perspective view of the MOV stack 100 of FIGS. 1A and 1B enclosed in a housing 130 to form a surge protection device 150 in accordance with some embodiments of the inventive concept. In some embodiments, the housing 130 that encapsulates the MOV stack 100 may comprise an electrical insulating material, such as an epoxy. As shown in FIG. 1C, the electrodes 125 and 127 may not be encapsulated by the housing 130 and may instead extend from the housing 130.

In accordance with some embodiments of the inventive concept, the MOV wafers 110 comprising the MOV stack 100 may be configured to have electrical characteristics that reduce an imbalance in current between respective MOV wafers 110 in response to an overvoltage event. A variety of different factors may affect the electrical characteristics of an MOV. Thus, the MOV wafers 110 comprising the MOV stack may be intentionally constructed with reduced variations in one or more factors, such as composition and size, relative to each other to reduce the current imbalance between the wafers 110 in response to an overvoltage event. By reducing the current imbalance among the various MOV wafers 110 in the stack, the stack may be more spatially isothermal, i.e., heat is distributed in a more spatially uniform manner across the stack. The factors affecting the electrical characteristics of an MOV wafer 110 and/or the consequences of the MOV behavior may include, but are not limited to, the following examples:

Material composition: The composition of the metal oxide used in the MOV wafer 110 affects its voltage capacity. Generally, zinc oxide or silicon carbide may be used as the main ingredient in MOV wafers 110.

Grain size: The grain size of the metal oxide in the MOV wafer 110 affects its varistor voltage. Smaller grain sizes increase the varistor voltage of the MOV wafer 110.

Impurities: The presence of impurities in the metal oxide can affect the voltage capacity of the MOV wafer 110. Impurities can lead to defects in the crystal structure, which can reduce the voltage capacity.

Manufacturing process: The manufacturing process used to make the MOV wafer 110 can affect its voltage capacity. The temperature, pressure, and other manufacturing conditions can affect the grain size and purity of the metal oxide.

Operating conditions: The voltage capacity of an MOV wafer 110 can also be affected by the operating conditions of the circuit it is protecting. Factors such as the magnitude and duration of the surge, as well as the frequency of surges, can affect the performance of the MOV wafer 110.

Maximum continuous voltage (Vcv): This is the maximum voltage that the MOV wafer 110 can continuously withstand without breaking down. It is usually specified in volts (V).

Varistor voltage: This is the voltage level at which that the MOV wafer 110 conducts a particular current, typically 1 Ma DC. It is usually specified in volts (Vdc).

Maximum clamping voltage (Vc or Vc (max)): This is the maximum voltage level seen across the MOV wafer 110 during an event containing the maximum peak current. It is usually specified in volts (V).

Energy absorption (W): This is the amount of energy that the MOV wafer 110 can absorb during a surge event without being damaged. It is usually specified in joules (J).

Response time: This is the time it takes for the MOV wafer 110 to respond and start clamping the voltage during a surge event. It is usually specified in microseconds (μs) and depends on the circuit configuration and operating conditions.

Leakage current (Ileak): This is the small amount of current that flows through the MOV wafer 110 when the circuit is under normal operating conditions. It is usually specified in microamperes (μA) and depends on the voltage applied across the MOV wafer 110.

Operating temperature range: This is the range of temperatures within which the MOV wafer 110 can operate safely and maintain its electrical properties. It is usually specified in degrees Celsius (° C.).

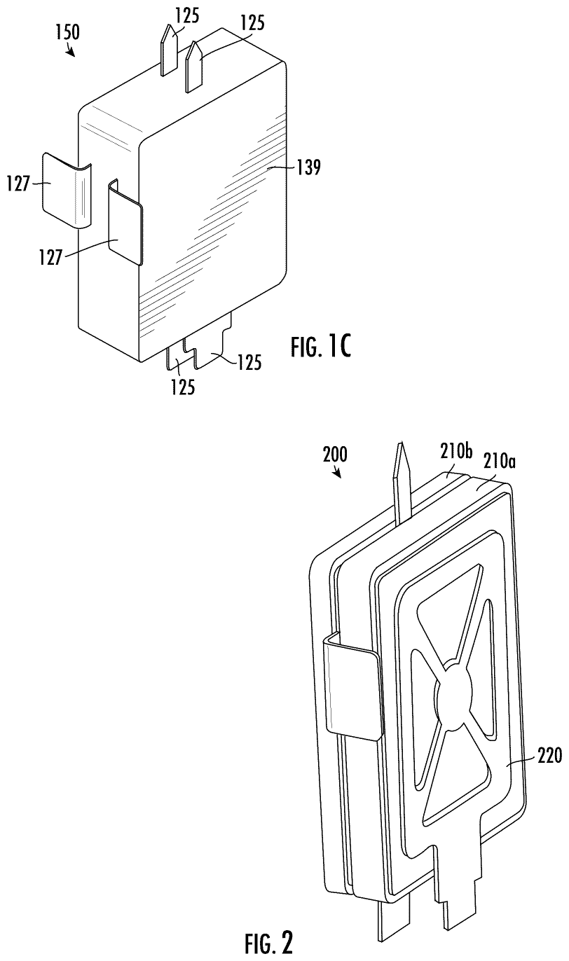

Another factor that can affect the electrical characteristics of the MOV wafer 110 is the thickness of the wafer. FIG. 2 is a perspective view of a MOV stack 200 for use in a surge protection device in which the MOV wafers 210a and 210b have different thicknesses in accordance with some embodiments of the inventive concept. As shown in FIG. 2, MOV wafer 210a is thicker than MOV wafer 210b.

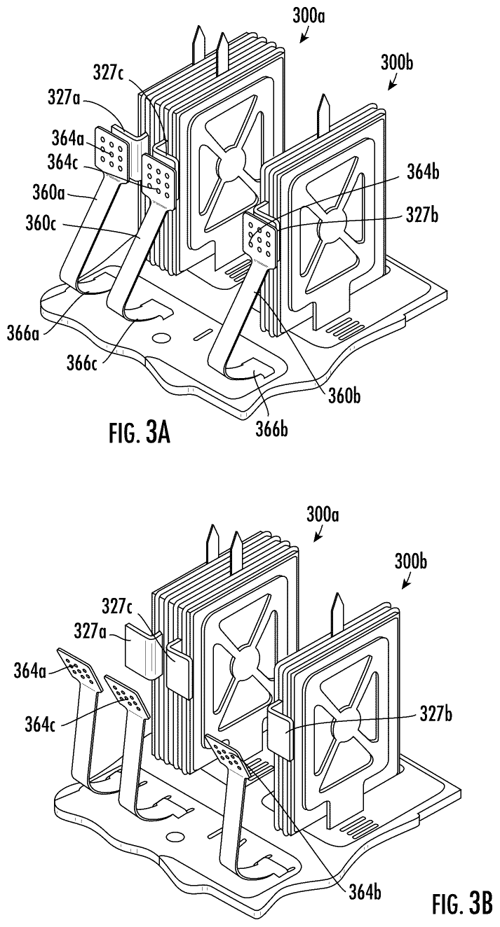

FIG. 3A is a perspective view of two MOV stacks 300a, 300b mounted on a base 355 each with disconnector elements 360a, 360b, 360c in a connected position attached thereto in accordance with some embodiments of the inventive concept. The base 355 may be a PCB in some embodiments of the inventive concept. FIG. 3B is a perspective view of the two MOV stacks 300a, 300b mounted on the base 355 each with the disconnector elements 360a, 360b, 360c in a disconnected position in accordance with some embodiments of the inventive concept. Referring to FIG. 3A, the MOV stack 300a includes two conductive plates with tab portions 327a and 327c, respectively, and the MOV stack 300b includes a conductive plate with tab portion 327b. Three disconnector elements 360a, 360b, and 360c may be configured with first ends 366a, 366b, and 366c coupled to ports that may each be a source of an overvoltage event with the other ends 364a, 364b, and 364c coupled to the tab portions 327a, 327b, and 327c, respectively. A conductive thermal adhesive, such as solder, may be used to form the attachment between the tab portions 327a, 327b, and 327c and the ends 364a, 364b, and 364c of the disconnector elements 360a, 360b, and 360c. The conductive thermal adhesive may soften in response to heat applied thereto, such as when an overvoltage event causes an increase in current that an associated isothermal temperature rise risks damage the SPD assembly. When the conductive thermal adhesive softens or melts, one or more of the disconnector elements 360a, 360b, and 360c may be biased to separate from the tab portions 327a, 327b, and 327c thereby disconnecting the MOV stack 300a and/or 300b from the source of the overvoltage event as shown in FIG. 3B. In the example of FIG. 3B, all three of the disconnector elements 360a, 360b, and 360c disconnect from the tab portions 327a, 327b, and 327c. This may protect the SPD assembly including the MOV stacks 300a and/or 300b from thermal damage caused by an overvoltage event.

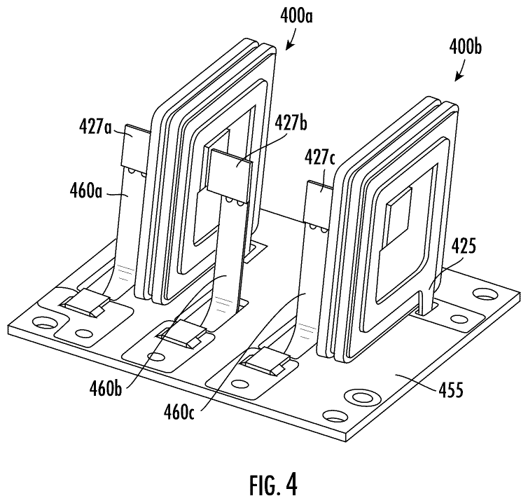

FIG. 4 is a perspective view of two MOV stacks 400a and 400b mounted on a base 455 with each MOV stack 400a, 400b coupled to two input connection ports. Specifically, the MOV stack 400a is coupled to a first connection port via tab portion 427a and disconnector element 460a and is coupled to a second connection port via tab portion 427b and disconnector element 460b. The MOV stack 400b is coupled to a third connection port via tab portion 427c and disconnector element 460c and is coupled to a fourth connection port via electrode 425. Thus, the multi-wafer MOV stacks 400a and 400b may each be coupled to multiple voltage sources simultaneously via ports on the base 455.

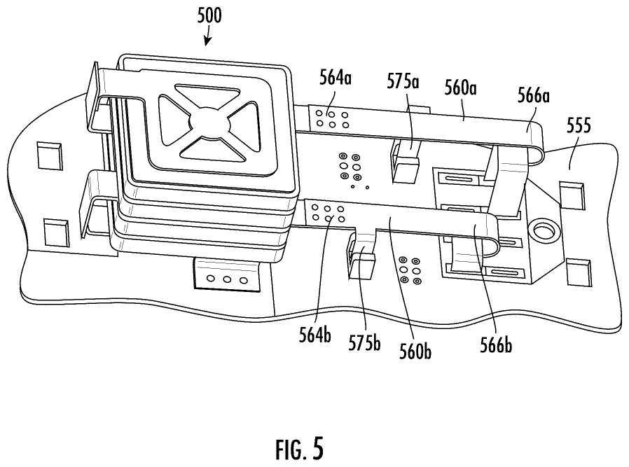

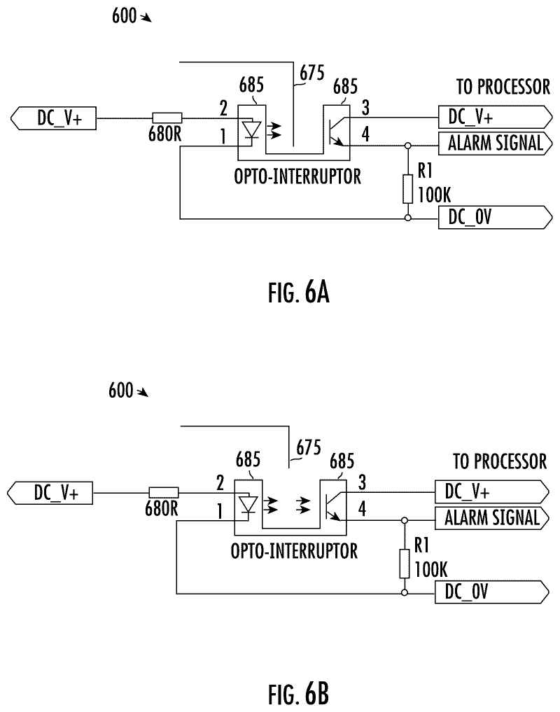

FIG. 5 is a perspective view of an MOV stack 500 with two disconnector elements 560a and 560b in a connected position according to some embodiments of the inventive concept. The two disconnector elements 560a and 560b have ends 564a and 564b, respectively, that are coupled to the MOV wafer stack 500 via a conductive thermal adhesive, such as solder, that is configured to soften in response to heat applied thereto as described above. The ends 566a and 566b may each be coupled to input connection ports that may be the source of an overvoltage event. It may be desirable to provide an alert mechanism when a disconnector element 560a and/or 560b disconnects from the MOV stack 500 due to excessive heat generated by an overvoltage event. Accordingly, in some embodiments of the inventive concept, the disconnector elements 560a and 560b may include beam splitter tabs 575a and 575b that are configured to engage an alert circuit as will be described below with reference to FIGS. 6A and 6B.

FIG. 6A is a circuit diagram of an alert circuit 600 in which the beam splitter tab 675, which may correspond to beam splitter tabs 575a and/or 575b, is in a connected position in accordance with some embodiments of the inventive concept; and FIG. 6B is a circuit diagram of the alert circuit 600 of FIG. 6A in which the beam splitter tab 675 is in a disconnected position in accordance with some embodiments of the inventive concept. The alert circuit 600 may be mounted on a base, such as the base 555 and may be configured to generate an alert signal when the tab portion of a parallelization plate or electrode separates from a disconnector element. As shown in FIG. 6A, the alert circuit 600 may comprise an optical generator 680, which may be a light emitting diode (LED) and an optical detection circuit 685, such as a photodetector. When a disconnector element is in a connected state, i.e., is connected to a tab portion of a parallelization plate or electrode of a MOV stack, the beam splitter tab 675 of a disconnector element may block the optical beam from being detected by the optical detector 685. When the disconnector element is in a disconnected state, i.e., is disconnected from the tab portion of a parallelization electrode of a MOV stack, the bias in the disconnector element may cause the beam splitter tab 675 to move away from being between the optical generator 680 and the optical detection circuit 685 to allow the optical detection circuit 685 to detect the optical beam generated by the optical generator 680. In response to detecting the optical beam, the optical detection circuit 685 may generate an output signal at the emitter terminal thereof, which may be used to drive a visual and/or audible warning component and/or may be processed using a processor to notify a responsible party that an overvoltage event has occurred that has caused an SPD to overheat and be disconnected from the overvoltage event by way of a disconnector element. This may allow a responsible party to take additional action to mitigate potential damage caused by the overvoltage event.

While some embodiments of the inventive concept have been illustrated with respect to FIGS. 5, 6A, and 6B in which multiple alert circuits are configured between multiple voltage sources and a single MOV stack, embodiments of the inventive concept are not limited thereto. In other embodiments, a single alert circuit may be used between a single voltage source and multiple MOV stacks are connected in parallel. In still other embodiments, a single alert circuit may be used between a single voltage source and a single MOV stack.

Some embodiments of the inventive concept described herein may, therefore, provide an SPD module including an MOV stack that may increase the current withstand and/or overvoltage surge capacity through improved isothermal temperature management in the MOV stack. The MOV wafers in the stack may be selected in a way to provide increased coordinated conduction during overvoltage current surges by lowering the imbalance in current flow between the MOV wafers in the MOV stack.

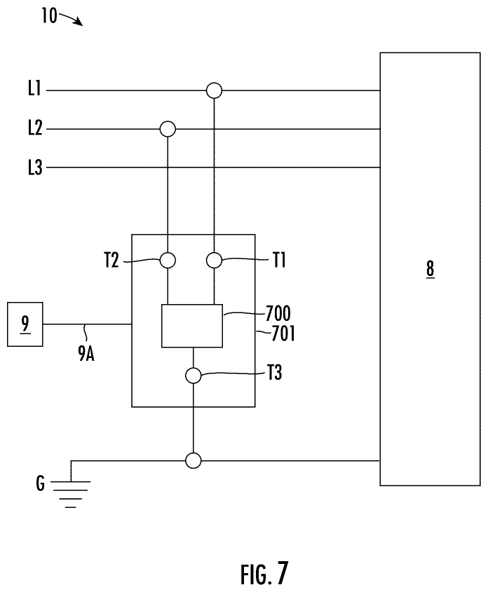

With reference to FIGS. 7-16, a modular surge protective device or module 700 according to embodiments of the present invention is shown therein and designated 700.

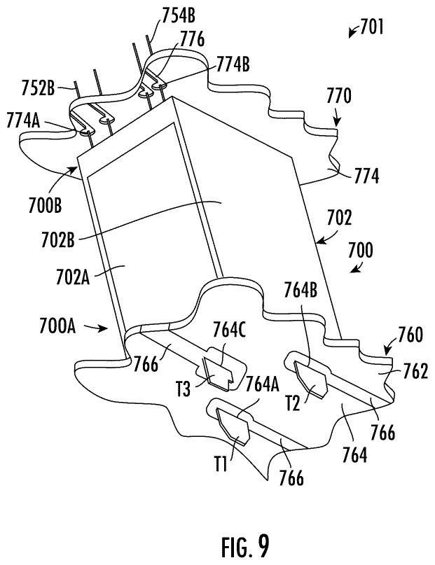

In some embodiments, the SPD module 700 is incorporated as a component of an SPD unit 701 as shown in FIGS. 7 and 9, for example. In some embodiments, the SPD module 700 or the SPD unit 701 is provided, installed and used as a component in a protection circuit of a power supply circuit 10 as shown in FIG. 7, for example. In the power supply circuit 10, the SPD module 700 is connected between a power electrical ground G and each of a power supply Line L1 and a power supply line L2, as discussed below. In some embodiments, the SPD module 700 is connected across sensitive equipment 8 and serves to protect the sensitive equipment 8 from overvoltages and current surges. The SPD module 700 may also be connected to the power source via an upstream second fuse or circuit breaker. As discussed herein, the SPD module 700 or the SPD unit 701 can be incorporated into other circuit configurations in accordance with other embodiments.

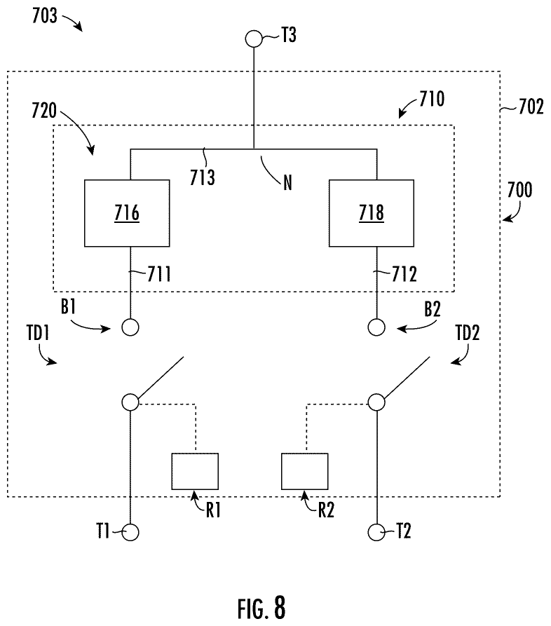

The SPD unit 701 includes the SPD module 700, a first PCB assembly 760, and a second PCB assembly 770. The SPD module 700 forms an SPD module electrical circuit 703, which is schematically shown in FIG. 8.

The SPD module 700 is configured as a unit or module. The SPD module 700 has a first end 700A and an opposing second end 700B. The ends 700A and 700B and other features are referred to herein as “top”, “bottom”, “upper” or “lower” only for the purpose of explanation. It will be appreciated that the SPD module 700 can assume any orientation and therefore these features are not limited to any such top/bottom or upper/lower relationship.

With reference to FIGS. 8-12, the SPD module 700 includes an outer housing or housing assembly 702, a varistor subassembly 710, a first terminal T1, a second terminal T2, a third or node terminal T3, a first thermal disconnector mechanism TD1, a second thermal disconnector mechanism TD2, a first signalization mechanism R1, and a second signalization mechanism R2.

The housing 702 includes a base housing part 702A and a cover 702B collectively forming the housing 702. The housing 702 defines an internal chamber or cavity. The components 710, TD1, TD2, R1 and R2 are disposed in the chamber. Openings are provided in the first end of the housing 702 for through passage of the terminals T1, T2, T3 and in the second end of the housing 702 for through passage of electrical leads 752B, 754B (discussed below).

The housing members 702A, 702B may be formed of any suitable material or materials. In some embodiments, each of the housing members 702A, 702B is formed of a rigid, electrically insulating, polymeric material. Suitable polymeric materials may include polyamide (PA), polypropylene (PP), polyphenylene sulfide (PPS), or ABS, for example.

The varistor subassembly 710 (FIGS. 8 and 12-14) includes a first varistor 716, a second varistor 718, a first contact electrode 711, a second contact electrode 712, a node electrode 713, and an electrically insulative casing 722.

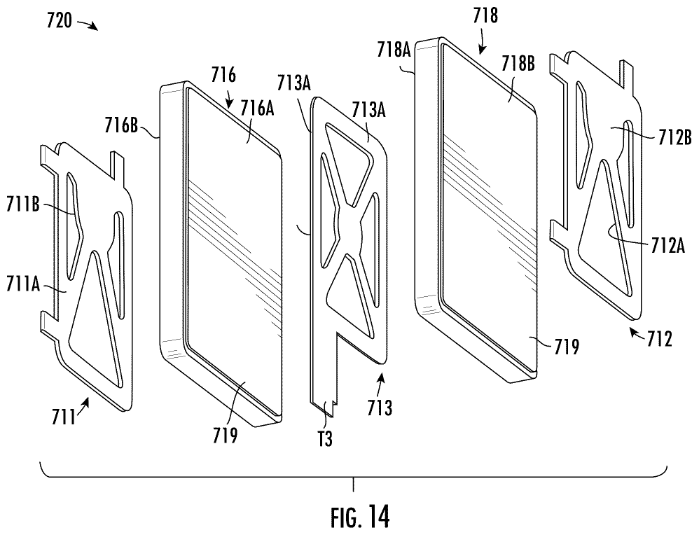

With reference to FIG. 14, the first varistor 716 has an inner contact surface 716A and an opposing outer contact surface 716B. The second varistor 718 has an inner contact surface 718A and an opposing outer contact surface 718B. Metallization layers 719 may cover the contact surfaces 716A, 716B, 718A, 718B, in which case the metallization layers constitute the contact surfaces of the varistors.

In some embodiments (e.g., as illustrated in FIG. 14), the varistors 716, 718 are varistor wafers.

The varistor material of each of the varistors 716, 718 may be any suitable material conventionally used for varistors, namely, a material exhibiting a nonlinear impedance characteristic with applied voltage. In some embodiments, the varistors 716, 718 are metal oxide varistors (MOV). In some embodiments, the impedance becomes very low when a prescribed voltage is exceeded. The varistor material may be a doped metal oxide or silicon carbide, for example. Suitable metal oxides include zinc oxide compounds. As discussed herein, the varistors 716, 718 may be of different compositions from one another.

With reference to FIG. 14, the first contact electrode 711 includes a varistor contact surface 711A and a thermal disconnect contact surface 711B. The second contact electrode 712 includes a varistor contact surface 712A and a thermal disconnect contact surface 712B. The node electrode 713 includes a varistor contact section 713C and the node terminal T3, which is integral with the varistor contact section 713C. The varistor contact section 713C has opposed varistor contact surfaces 713A.

The electrodes 711, 712, 713 are electrically conductive. In some embodiments, the electrodes 711, 712, 713 are formed of metal. Suitable metals may include nickel brass or copper alloys such as CuSn 6 or Cu-ETP. In some embodiments, the electrodes 711, 712, 713 are unitary (composite or monolithic) and, in some embodiments, the electrodes 711, 712, 713 are monolithic.

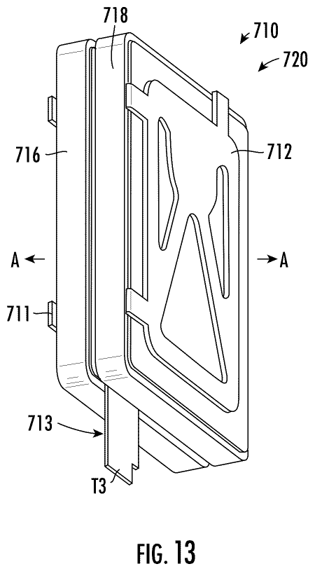

With reference to FIGS. 13 and 14, the electrodes and varistors are layered or stacked in intimate contact to such that they collectively form a component or varistor stack assembly 720 including the varistors 716, 718 and the electrodes 711, 712, 713. The varistor contact section 713C of the node electrode 713 is interposed between the varistors 716, 718 such that the varistor contact surfaces 713A engage and make electrical contact with the inner contact surfaces 716A, 718A. The first contact electrode 711 is mounted on the outer side of the varistor 716 such that the varistor contact surface 711A engages and makes electrical contact with the outer contact surface 716B. The second contact electrode 712 is mounted on the outer side of the varistor 718 such that the varistor contact surface 712A engages and makes electrical contact with the outer contact surface 718B. Thus, the components of the varistor stack assembly 720 are intimately layered, stacked or assembled along a stack axis A-A (FIG. 13) in the order: electrode 711; varistor 716; electrode 713; varistor 718; electrode 712.

The casing 722 envelops or encapsulates the varistor stack assembly 720 and provides proper electrical insulation between the varistors 716, 718. The terminal T3 projects through and outward from the casing 722. Opposed contact openings 722A are defined in the casing 722. Each of the thermal disconnect contact surfaces 711B, 712B is aligned with and exposed through a respective one of the contact openings 722A.

The casing 722 may be formed of any suitable electrically insulating material. In some embodiments, the casing 722 is formed of an epoxy.

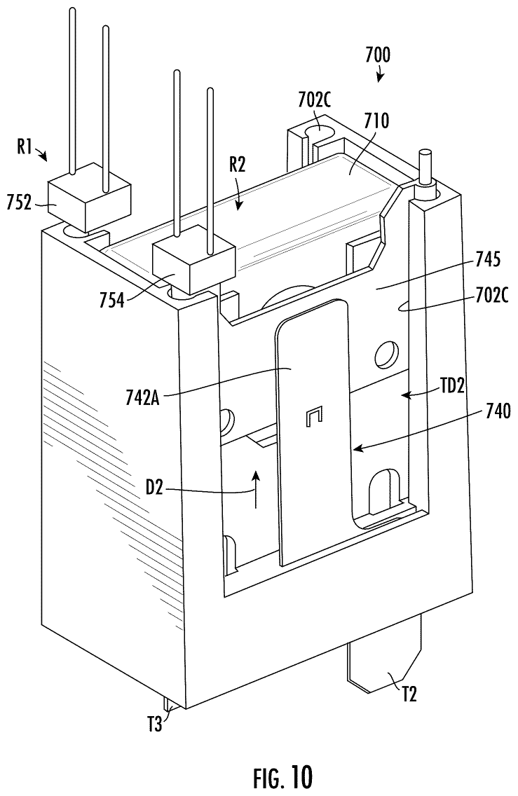

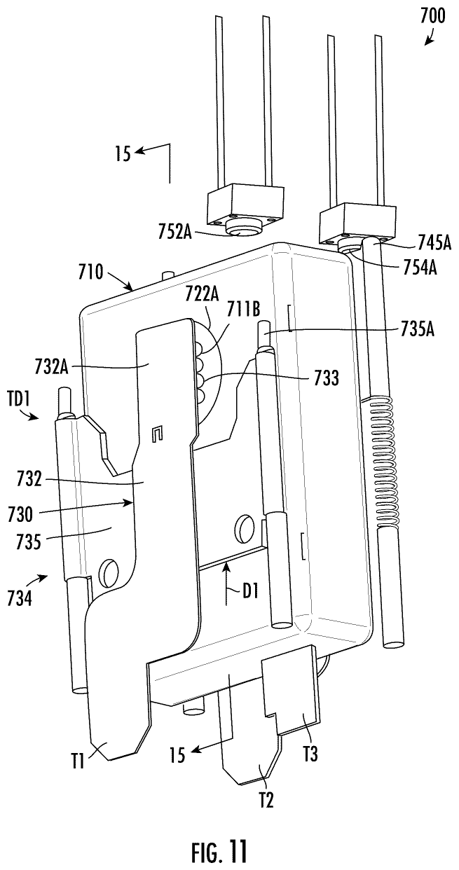

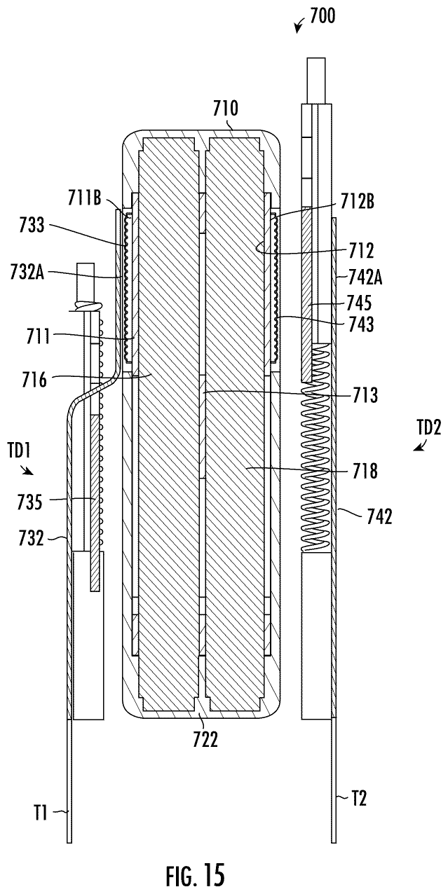

The first and second thermal disconnector mechanisms TD1, TD2 are fail-safe mechanisms adapted to prevent or inhibit overheating or thermal runaway of the varistors 716, 718, as discussed in more detail below. Each of the thermal disconnector mechanisms TD1, TD2 is initially disposed in non-actuated configuration or state and will assume or transition to an actuated configuration or state in response to certain conditions. In its non-actuated state, the thermal disconnector mechanism TD1 provides electrical connectivity between the terminal T1 and the varistor 716. In its non-actuated state, the thermal disconnector mechanism TD2 provides electrical connectivity between the terminal T2 and the varistor 718. In its actuated state, the thermal disconnector mechanism TD1 opens the electrical circuit between the terminal T1 and the varistor 716. In its actuated state, the thermal disconnector mechanism TD2 opens the electrical circuit between the terminal T2 and the varistor 718. The thermal disconnector mechanism TD1 is shown in its non-actuated state in FIGS. 11 and 15, and the thermal disconnector mechanism TD2 is shown in its actuated state in FIGS. 10 and 15. However, it will be appreciated that the thermal disconnector mechanisms TD1 and TD2 will both be in their non-actuated state initially (i.e., at the time of installation in the circuit 10 or other power circuit to be protected from overvoltages), and will each transition to its actuated state when triggered or actuated.

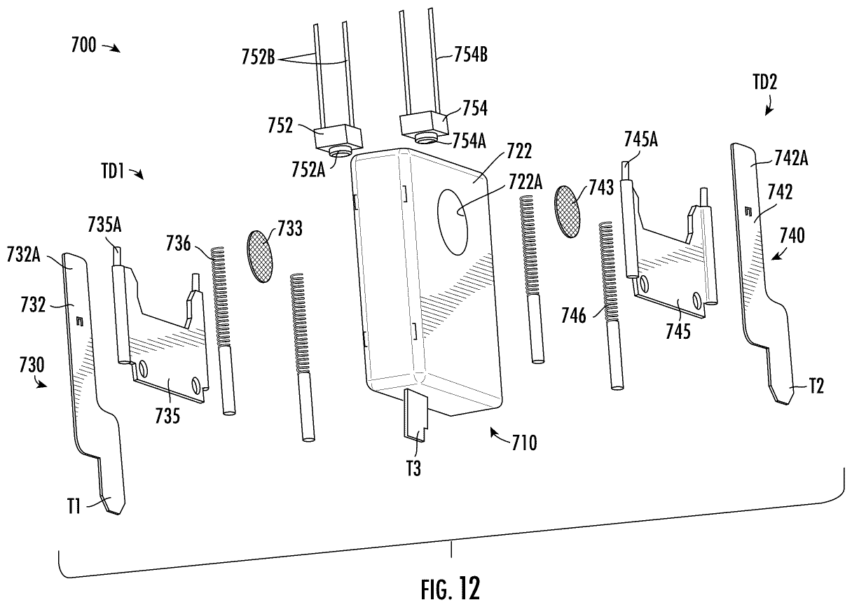

With reference to FIGS. 11 and 12, the first thermal disconnector mechanism TD1 includes a first disconnect arm member or electrode 730, a meltable component or layer 733, and a first isolation mechanism 734. In some embodiments, the meltable component 733 is a layer of electrically conductive, meltable adhesive. In some embodiments and as shown, the meltable component 733 is a layer of electrically conductive solder.

The first disconnect arm electrode 730 includes a first arm 732 and the first terminal T1. The first arm 732 includes a first thermal disconnect contact section 732A. The first thermal disconnect contact section 732A is affixed to the thermal disconnect contact surface 711B by the solder 733, which engages each.

The first disconnect arm electrode 730 is electrically conductive. In some embodiments, the first disconnect arm electrode 730 is formed of metal. Suitable metals may include nickel brass or copper alloys such as CuSn 6 or Cu-ETP. In some embodiments, the first disconnect arm electrode 730 is unitary (composite or monolithic) and, in some embodiments, the first disconnect arm electrode 730 is monolithic.

The first isolation mechanism 734 includes a slidable first barrier member 735, springs 736, and guide channels 702C in the housing 702. The first barrier member 735 is slidably seated in the guide channels 702C. The first barrier member 735 is interposed between the first arm 732 and the casing 722.

The first barrier member 735 is formed of an electrically insulating material. In some embodiments, the first barrier member 735 is formed of a polymer. Suitable electrically insulating materials may include FRP or PVC, for example.

The first thermal disconnect mechanism TD1 is configured and operable to transition from a ready position (as shown in FIGS. 11 and 15) to a disconnect position (corresponding to the position of the second thermal disconnector mechanism TD2 in FIG. 10) in response to softening or melting of the solder 733 (or other suitable meltable component). In the ready position, the first thermal disconnect contact section 732A is affixed to the thermal disconnect contact surface 711B by the solder 733 and the first barrier member 735 is held in the retracted position by the arm 732. When the solder 733 is sufficiently softened, the springs 736 force the first barrier member 735 to slide in a disconnect direction D1 (FIG. 11) until the first barrier member 735 assumes the disconnect position, wherein the first barrier member 735 is fully interposed between the first thermal disconnect contact section 732A and the thermal disconnect contact surface 711B. The spring-loaded first barrier member 735 displaces the arm 732 away from the varistor stack assembly 720. The first disconnect electrode 730 is thereby electrically disconnected from and electrically isolated from the first contact electrode 711. The first barrier member 735 is interposed between the arm 732 and the electrode 711 so that the first barrier member 735 provides electrical insulation and isolation between the components and quenches arcing between the components.

With reference to FIGS. 10 and 12, the second thermal disconnector mechanism TD2 includes a second disconnect arm member or electrode 740, a meltable component or layer 743, a second barrier mechanism 744, a slidable second barrier member 745, springs 746, and guide channels 702C corresponding to and constructed and operative in the same manner as described above for the components 730, 733, 734, 735, 736, and 702C, respectively, of the first thermal disconnector mechanism TD1. The second barrier member 745 is slidably seated in the guide channels 702C and interposed between the second arm 742 and the casing 722.

The second thermal disconnector mechanism TD2 is configured and operable to transition from its ready position (corresponding to the position of the first thermal disconnector mechanism TD1 in FIG. 11) to its disconnect position (as shown in FIGS. 10 and 15) in response to softening or melting of the solder 743. In the ready position, the second barrier member 745 is retracted and the second thermal disconnect contact section 742A is affixed to the thermal disconnect contact surface 712B by the solder 743. When the solder 743 is sufficiently softened, the springs 746 force the second barrier member 745 to slide in a disconnect direction D2 until the second barrier member 745 assumes the disconnect position, wherein the second barrier member 745 is fully interposed between the second thermal disconnect contact section 742A and the thermal disconnect contact surface 712B. The spring-loaded second barrier member 745 displaces the arm 742 away from the varistor stack assembly 720. The second disconnect electrode 740 is thereby electrically disconnected from and electrically isolated from the second contact electrode 712.

In some embodiments, the disconnect arms 732, 742 are elastically deflected when soldered to the contact surfaces 711B, 712B. As a result, the spring force of the deflected arm 732, 742 tends to pull the arm 732, 742 away from and out of contact with the surface 711B, 712B when the arm 732, 742 is released by the solder 733, 743.

It will be appreciated that the first and second thermal disconnect mechanisms TD1, TD2 operate independently of one another. That is, in some circumstances, the first thermal disconnect mechanism TD1 will be triggered and transition to its disconnect position while the second thermal disconnect mechanism TD2 remains in its ready position, and in other circumstances, the second thermal disconnect mechanism TD2 will be triggered and transition to its disconnect position while the first thermal disconnect mechanism TD1 remains in its ready position.

The first and second signalization mechanisms R1, R2 serve to indicate disconnection states of the varistor stack assembly 720.

The first signalization mechanism R1 includes a first electrical switch 752 and an actuation feature or prong (on the first barrier member 735) 735A. The switch 752 includes actuation contact 752A and electrical leads 752B. The leads 752B extend out through the housing 702.

The second signalization mechanism R2 includes a second electrical switch 754 and an actuation feature or prong (on the second barrier member 745) 745A. The switch 754 includes actuation contact 754A and electrical leads 754B. The leads 754B extend out through the housing 702.

The SPD module 700 is configured such that the prong 735A of the spring-loaded first barrier member 735 depresses the actuation contact 752A when the barrier member 735 assumes its disconnect position. Likewise, the SPD module 700 is configured such that the prong 745A of the spring-loaded second barrier member 745 depresses the actuation contact 754A when the barrier member 745 assumes its disconnect position. In this way, each of the thermal disconnect mechanisms TD1 and TD2 will actuate its associated signalization mechanism R1 or R2 independently of the other.

The first PCB assembly 760 includes a first PCB 762. The PCB 762 includes an electrically insulating PCB substrate 764 and a plurality or pattern(s) of electrically conductive (e.g., copper) layers laminated to the substrate and embodied in the PCB 762, as is known in the art. In the illustrated embodiment, these electrically conductive layers include traces 766 and PCB electrical contacts in the form of through hole contacts 764A, 764B, 764C. The through hole contacts 764A, 764B, and 764C are configured to receive and electrically contact the terminals T1, T2, and T3, respectively, and electrically connect the terminals T1, T2, and T3 to respective lines (including, in some embodiments, a ground line) of the electrical circuits as described herein (e.g., the circuits illustrated in FIGS. 7, 16 and 19-25).

The second PCB assembly 770 includes a second PCB 772. The PCB 772 includes an electrically insulating PCB substrate 774 and a plurality or pattern(s) of electrically conductive (e.g., copper) layers laminated to the substrate and embodied in the PCB 772, as is known in the art. In the illustrated embodiment, these electrically conductive layers include traces 776 and PCB electrical contacts in the form of through hole contacts or pads 774A, 774B. The through hole contacts 774A and 774B electrically connect the signalization leads 752B and 754B to respective lines of a remote signaling circuit as described herein.

The PCBs 762, 772 may include other electrically conductive traces, pads, vias, and/or plated through-holes, for example. The PCB assemblies 760, 770 may include additional electrical components mounted on the PCB substrates 764, 774.

The PCB substrates 764, 774 may be formed of any suitable rigid, electrically insulating material, such as fiberglass FRI, fiberglass FR4, epoxics, and glass epoxies (such as CEM-1, G11), or polytetrafluoroethylene (PTFE).

The SPD module electrical circuit 703 (FIG. 8) of the SPD module 700 includes: a first terminal T1; a second terminal T2; a third terminal T3; and a node N (the node electrode 713). The node N is electrically connected to the third terminal T3. The SPD module electrical circuit 703 includes a first branch B1 including: the first varistor 716 electrically connected between the first terminal T1 and the node N; and the first thermal disconnector TD1 configured to disconnect the first varistor 716 from the first terminal T1. The SPD module electrical circuit 703 further includes a second branch B2 including: the second varistor 718 electrically connected between the second terminal T2 and the node N; and the second thermal disconnector TD2 configured to disconnect the second varistor 718 from the second terminal T2. The first and second branches B1, B2 are in electrical parallel between the terminals T1, T2 and the terminal T3.

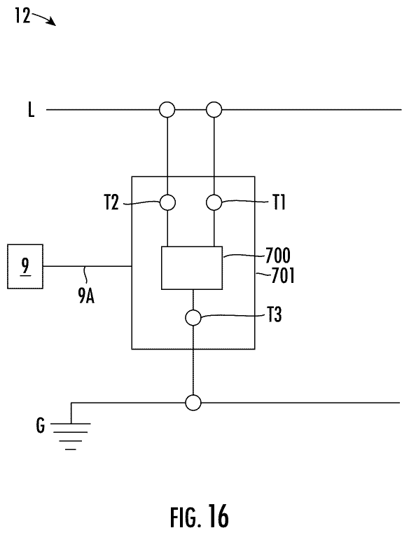

The SPD unit 701 and the SPD module 700 can be used in different setups, circuits, configurations or applications. In some embodiments, the SPD unit 701 and the SPD module 700 are used in a dual mode overvoltage protection configuration. In other embodiments, the SPD unit 701 and the SPD module 700 are used in a common mode overvoltage protection configuration. As discussed in more detail below, the SPD module 700 can be used in multiple different, alternative dual mode overvoltage protection configurations and in multiple different, alternative common mode overvoltage protection configurations. In a dual mode overvoltage protection configuration according to embodiments of the technology, two different voltage potentials (connected at the terminals T1 and T2, respectively) are connected in parallel to a third voltage potential (connected at the terminal T3). In a common mode overvoltage protection configuration according to embodiments of the technology, a single potential (connected at both of the terminals T1 and T2) is connected through parallel varistors 716, 718 to a second voltage potential (connected at the terminal T3). FIG. 7 illustrates the SPD module 700 installed in an example dual mode overvoltage protection configuration. FIG. 16 illustrates the SPD module 700 installed in an example common mode overvoltage protection configuration.

In the example setup of FIG. 7, the configuration is dual mode with the first mode being L1-G and the second mode being L2-G. The line L1 is electrically connected to the first terminal T1, the second line L2 is electrically connected to the second terminal T2, and the ground line G is electrically connected to the third terminal T3. In the example embodiment, the lines L1, L2, G are connected to the terminals T1, T2, T3 via the traces 766 and contacts 764A, 764B, 764C of the PCB assembly 760. However, other techniques for connecting the lines to the terminals may be used in accordance with other embodiments.

The line L1 is thereby selectively electrically connected to the ground G via the first branch B1 and is protected by the first varistor 716. The line L2 is thereby selectively electrically connected to the ground G via the second branch B2 and is protected by the second varistor 718.

During normal operation (referred to herein as Varistor Operation Mode 1), the varistor 716 presents a high impedance between the electrode 711 and the electrode 713, and the varistor 718 presents a high impedance between the electrode 712 and the electrode 713. The thermal disconnector mechanisms TD1, TD2 each remain in their ready position, with the contact portion 732A, 742A of the respective disconnect arm 732, 742 bonded to and in electrical continuity with the electrode contact portion 711B or 712B by the solder 733 or 743. In this normal mode, each varistor 716, 718 is in a high impedance state. In this mode, the thermal disconnector mechanisms TD1, TD2 are not actuated.

In the event of a transient overvoltage or surge current in line L1 or line L2, protection of power system load devices may necessitate providing a current path to ground G for the excess current of the surge current.

A surge current in the line L1 may generate a transient overvoltage between the line L1 and ground G (i.e., between terminal T3 and terminal T1) that overcomes the isolation of the first varistor 716. In this event and mode (referred to herein as Varistor Operation Mode 2), the varistor 716 is subjected to an overvoltage exceeding VNOM, and temporarily and reversibly transitions to a low impedance, conductive state. The first varistor 716 will then divert, shunt or allow the surge current or impulse current to flow from the terminal T1 to the terminal T3 through the varistor 716 for a short duration.

Likewise, a surge current in the line L2 may generate a transient overvoltage between the line L2 and ground G (i.e., between terminal T3 and terminal T2) that overcomes the isolation of the second varistor 718. In this event, the varistor 718 is subjected to an overvoltage exceeding VNOM, and temporarily and reversibly becomes a low impedance electrical conductor. The second varistor 718 will then divert, shunt or allow the high surge current or impulse current to flow from the terminal T2 to the terminal T3 through the varistor 718 for a short duration.

In Varistor Operation Mode 2 (on either line L1, L2), the corresponding thermal disconnector mechanism TD1, TD2 does not operate because the overvoltage event is short in duration and the heat generated by the surge current is insufficient to melt the solder 733, 743.

In a third mode (Varistor Operation Mode 3), the varistor 716 is in its the end-of-life state. This type of varistor failure could be the result of multiple surge/impulse currents. The leakage current generates heat in the varistor 716 from ohmic losses. In some cases, the leakage current occurs during normal operation and is low (e.g., less than 1 mA). The heat generated in the varistor 716 progressively deteriorates the varistor 716 and builds up over an extended duration.

In Varistor Operation Mode 3, the first thermal disconnector mechanism TD1 operates. More particularly, the heat (e.g., from ohmic losses in the varistor 716) is transferred from the varistor 716 to the electrode 711, and then to the solder 733. Over an extended time period (e.g., in the range of from about five seconds to one minute), the heat builds up in the solder 733 until the solder 733 melts. The melted solder 733 releases the disconnect arm 732, which permits the first barrier member 735 to assume the disconnect position open the circuit branch B1 in the SPD module 700. The varistor 716 is thereby prevented from catastrophically overheating.

Likewise, in its Operation Mode 3 operation, the second varistor 718 is in end-of-life state. The leakage current generates heat in the varistor 718 from ohmic losses. The heat generated in the varistor 718 progressively deteriorates the varistor 716 and builds up over an extended duration

In Varistor Operation Mode 3 operation of the second varistor 718, the second thermal disconnector mechanism TD2 operates. More particularly, the heat (e.g., from ohmic losses in the varistor 718) is transferred from the varistor 718 to the electrode 712, and then to the solder 743 (or other electrically conductive, meltable adhesive). Over an extended time period, the heat builds up in the solder 743 until the it melts. The melted solder 743 releases the disconnect arm 742, which permits the first barrier member 745 to assume the disconnected position and open the circuit branch B2 in the SPD module 700. The varistor 718 is thereby prevented from catastrophically overheating.

In a fourth mode (Varistor Operation Mode 4), the varistor 716 or 718 is in good condition, but there is a Temporary Overvoltage (TOV) event wherein the voltage across the terminals T1 and T3 (in the case of varistor 716) or T2 and T3 (in the case of varistor 718) that forces the varistor 716 or 718 to conduct a sufficiently large surge current over a sufficient duration to trigger the disconnector mechanism TD1 or TD2.

It will be appreciated that the two overvoltage protection paths (i.e., line L1 to ground G; and line L2 to ground G) operate electrically independently of one another. That is, even though the two varistors 716, 718 and electrodes 711, 712, 713 are part of the varistor stack assembly 720 and SPD module 700, and the lines L1, L2, G are connected through the varistor stack assembly 720 and SPD module 700, the varistor 716 protects only the line L1 and the varistor 718 protects only the line L2.

Moreover, it will be appreciated that the thermal disconnect mechanisms TD1, TD2 operate independently of one another. If one varistor 716, 718 fails, it will be brought offline (i.e., its branch B1, B2 will be opened) by the associated thermal disconnect mechanism TD1, TD2 while the other varistor 716, 718 will remain in service.

The first and second signalization mechanisms R1, R2 will also operate independently of one another to signal to an observer or recorder that their associated thermal disconnect mechanism TD1, TD2 has assumed its disconnect state. The remote monitoring device 9 is electrically and operatively connected to the SPD module 700 by remote leads 9A is connected to the first switch 752 (i.e., via a trace 766 and leads 752B) and the second switch 754 (i.e., via a trace 766 and leads 754B). The remote monitoring device 9 may be any suitable device or circuit operative to detect and process the signals.

With reference to FIG. 16, a power supply circuit 12 according to further embodiments is shown therein. In the circuit 12, the SPD module 700 and the SPD unit 701 are incorporated therein in an L-G common mode overvoltage protection configuration. In this case, a line L is electrically connected to the first terminal T1, the line L is also electrically connected to the second terminal T2, and the ground line G is electrically connected to the third terminal T3. In the example embodiment, the lines L, G are connected to the terminals T1, T2, T3 via the traces 766 and contacts 764A, 764B, 764C of the PCB assembly 760. However, other techniques for connecting the lines to the terminals may be used in accordance with other embodiments.

The line L is thereby selectively electrically connected to the ground G via both the first branch B1 and the second branch B2 in electrical parallel. The line L is thereby protected by both varistors 716, 718. Only two electrical potentials are connected by the SPD module 700. In this configuration, the SPD module 700 provides increased (double) surge current withstand capacity via a relatively small footprint due to the ability to stack the varistors 716 and 718 as described herein.

Again, the thermal disconnector mechanisms TD1, TD2 operate independently of one another. If one varistor 716, 718 fails, it will be taken offline (i.e., its branch B1, B2 will be opened) by the associated thermal disconnect mechanism TD1, TD2 and the other varistor 716, 718 will remain in service.

It will be appreciated that each of the two varistors 716, 718 will protect the line L even after the other varistor has been disconnected by the other varistor's thermal disconnect mechanism TD1, TD2. This enables the SPD module 700 to provide staged overvoltage protection. In a first stage or level, the line L is protected by both varistors 716, 718 (operating in electrical parallel). In a second stage, one of the varistors 716, 718 has failed and been disconnected by its thermal disconnect mechanism TD1, TD2, the other varistor has not failed, and the line L is protected by the varistor that has not failed. In a third stage, both varistors 716, 718 have failed and been disconnected by their thermal disconnect mechanisms TD1, TD2, and the line L is no longer protected by the SPD module 700.

The first and second signalization mechanisms R1, R2 will operate independently of one another to signal to an observer or recorder that their associated thermal disconnect mechanism TD1, TD2 has assumed its disconnect state. In this case, the SPD module 700 will thereby provide a higher resolution signal communication to the observer or recorder that indicates which of the three stages the SPD 700 has assumed. In the first stage condition, neither switch 752, 754 is actuated and signaling, in the second stage condition, one of the switches 752, 754 is actuated and signaling, and in the third stage condition, both of the switches 752, 754 are actuated and signaling.

The first and second signalization mechanisms R1, R2 use mechanically actuated, electrical signal generating switches 752, 754. The switches 752, 754 are isolated in that they are not electrically connected to the circuit being monitored. Therefore, the signalization circuit can run at any suitable voltage.

According to different embodiments, the varistor stack assembly 720 may be configured in different ways to provide multi-mode protection where surge events may be dissipated through the SPD module 700 via multiple different types of paths, such as a power line to power line path (L-L), a power line to neutral path (L-N), and/or a power line to ground path (L-G). In addition, the varistor stack assembly may be configured to provide only a single mode of protection between a power line and a ground line (L-G), between a power line and a neutral line (L-N), and/or between a first power line and a second power line (L-L).

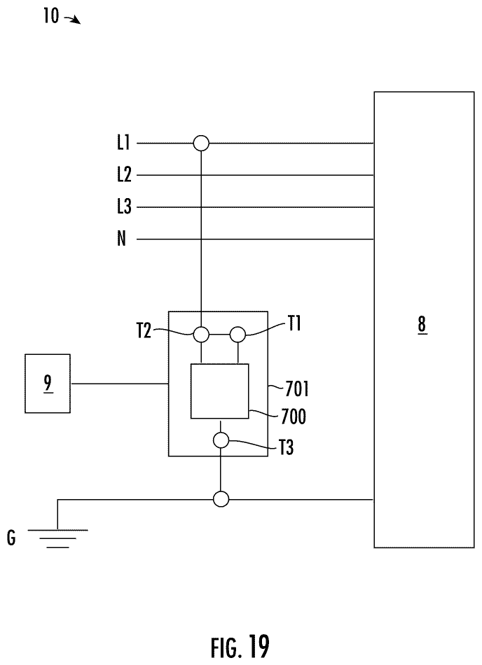

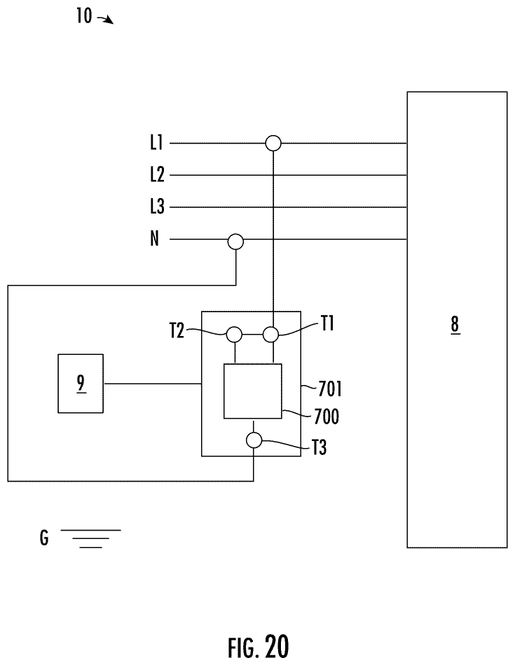

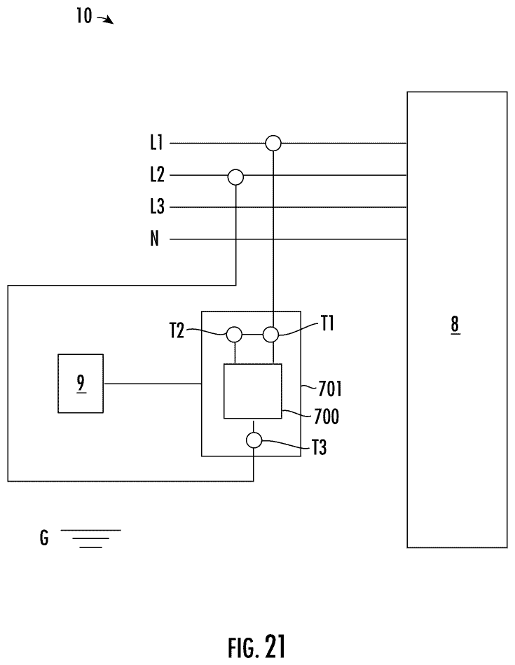

FIGS. 19-21 illustrate example circuit block diagrams of the SPD module 700 arranged in different single mode configurations. Referring to FIG. 19, the first and second terminals T1 and T2 associated with the first and second varistors 716 and 718, respectively, are shown to be electrically connected to one another. This results in the first and second varistors 716 and 718 being connected in parallel between a common terminal corresponding to the electrical connection of the first and second terminals T1 and T2 to each other and the third terminal T3. By connecting the two varistors 716 and 718 in parallel, the varistor stack assembly 720 may provide increased surge capacity in a relatively smaller footprint. The SPD module 700 provides only a single mode of protection when the terminals T1, T2, and T3 are configured in this manner. In the example of FIG. 19, the power line to ground line (L-G) protection is provided through the SPD module 700. In the example of FIG. 20, power line to neutral line (L-N) protection is provided through the SPD module 700. In the example of FIG. 21, power line to power line (L-L) protection is provided through the SPD module 700. The power lines L1, L2, and L3 may be power lines in a single phase power system or phase lines in a multiple phase power system. The ground line G may be a true earth ground.

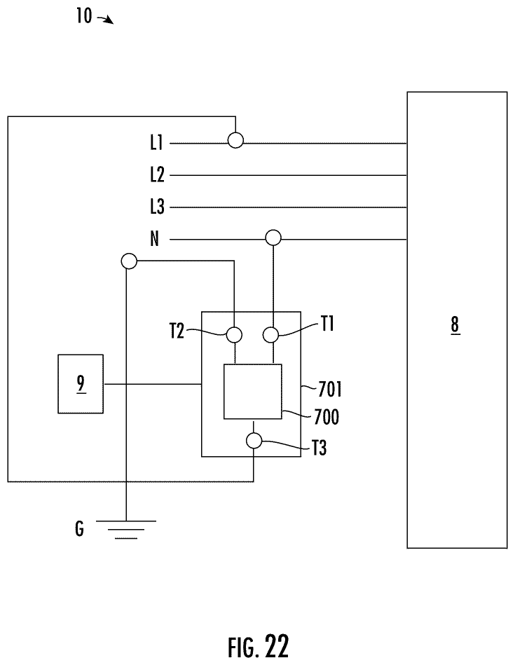

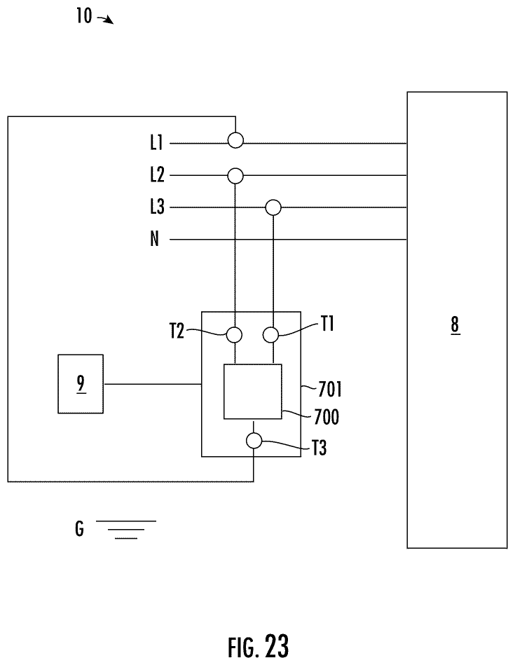

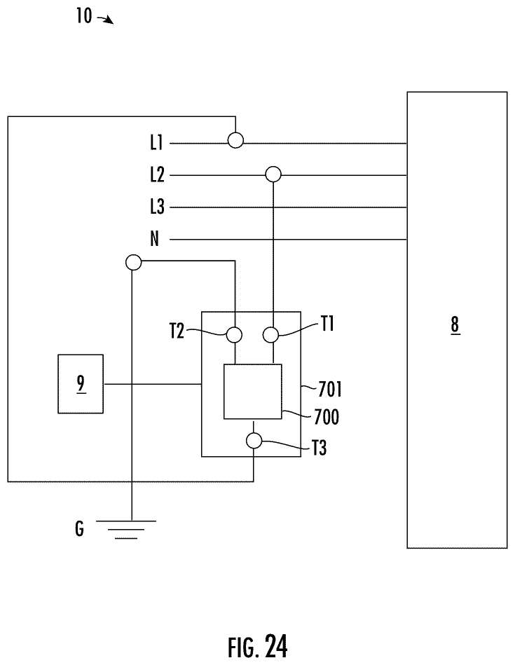

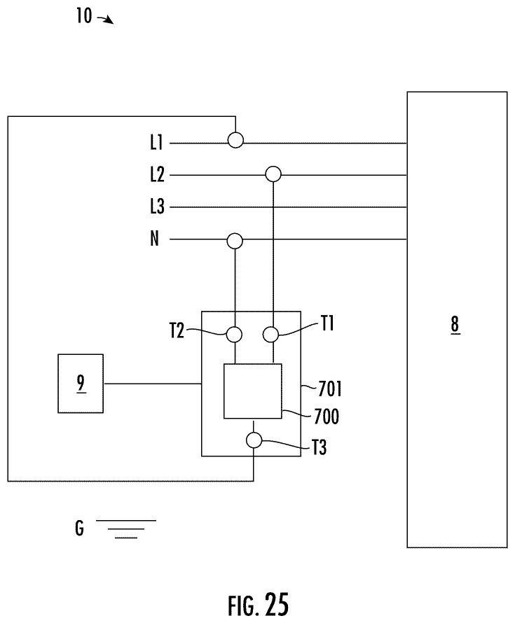

FIGS. 22-25 illustrate example circuit block diagrams of the SPD module 700 arranged in different multi-mode configurations. The multi-mode configurations allow one of the two varistors 716 and 718 to be configured for one type of protection (L-L, L-N, or L-G) and the other of the two varistors 716 and 718 to be configured for the same or different type of protection (L-L, L-N, or L-G) as the first varistor. Referring now to FIG. 22, the first varistor 716 is connected between line L1 and the neutral line N in an L-N configuration and the second varistor 718 is connected between line L1 and the ground line G. The multi-mode configuration of providing both an L-N mode and an L-G mode through the SPD module 700 may allow for increased effectiveness of each mode due to isothermal properties of the stacked design and the current sharing of the different modes. The stacked design of the varistor stack assembly 720 may also provide for a reduced footprint relative to discrete metal oxide varistors. FIG. 23 illustrates a multi-mode configuration in which the first varistor 716 is connected between line L1 and line L3 in an L-L configuration and the second varistor 718 is connected between line L1 and line L2 in an L-L. Thus, in the example of FIG. 23, the two different varistors 716 and 718 operate in the same L-L mode between different pairs of power lines. FIG. 24 illustrates a multi-mode configuration in which the first varistor 716 is connected between line L1 and line L2 in an L-L configuration and the second varistor 718 is connected between line L1 and the ground line G in an L-G configuration. Thus, in the example of FIG. 24, the two different varistors 716 and 718 operate in different modes L-L and L-G. FIG. 25 illustrates a multi-mode configuration in which the first varistor 716 is connected between line L1 and line L2 in an L-L configuration and the second varistor 718 is connected between line L1 and the neutral line G in an L-N configuration. Thus, in the example of FIG. 25, the two different varistors 716 and 718 operate in different modes L-L and L-N. Similar to the example of FIG. 22, the multi-mode configurations illustrated in FIGS. 23-25 through the SPD module 700 may allow for increased effectiveness of each mode due to the isothermal properties of the stacked design and the current sharing of the varistors in the different modes. These examples also incorporate the stacked design of the varistor stack assembly 720, which provides for a reduced footprint relative to discrete metal oxide varistors.

The varistors 716 and 718 may also have different MOV ratings, which may be used in DELTA electrical systems, such as 240V, 480V, and 600V systems. These systems may use L-L and L-G modes of surge protection. The SPD 700 may be configured to provide multiple modes of protection with the benefit of, for example, reducing the clamping voltage in the L-L mode while taking up a smaller footprint compared to discrete varistor designs.

In some embodiments, the varistors 716 and 718 may have different voltage ratings, such as 550V and 275V, which may be referred to as a 550/275 stack. The varistor with the 550V rating may be connected in an L-G mode and the varistor with the 275V rating may be connected in an L-L mode. In some embodiments, the varistor with the 275V rating may be connected in series with a 275V rated varistor from another varistor stack assembly to create a configuration with a 550V L-G mode and a 275V+275V or 550V L-L mode.

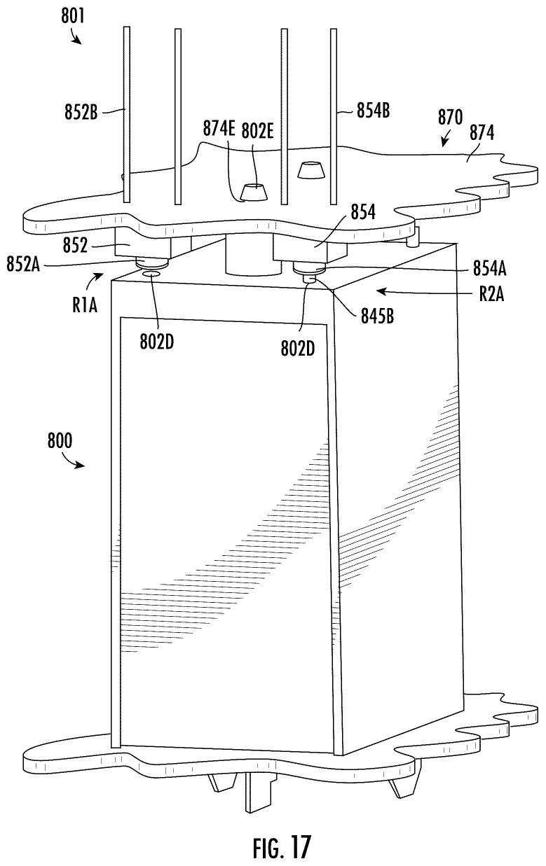

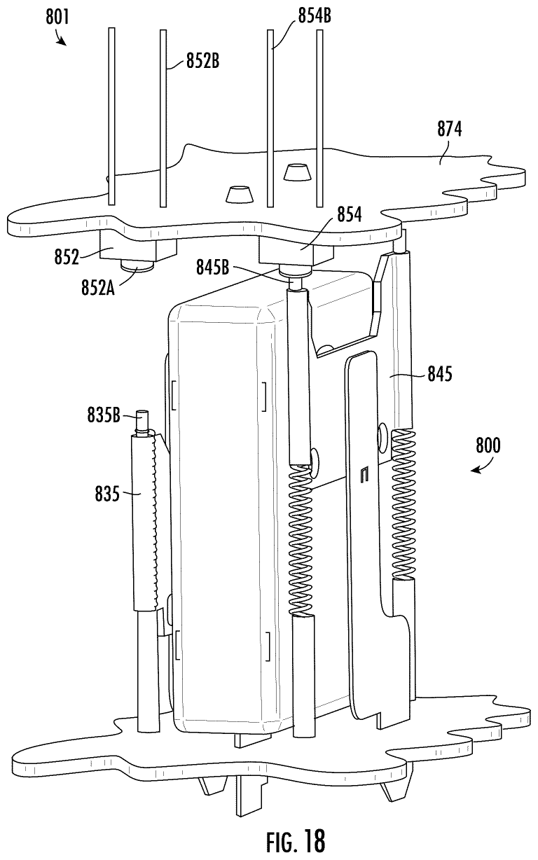

With reference to FIGS. 17 and 18, an SPD module 800 and an SPD unit 801 including the same are shown therein. The SPD module 800 and SPD unit 801 are constructed and operate in the same manner as the SPD module 700 and an SPD unit 701, except as discussed below. The SPD module 800 and SPD unit 801 can be used in place of the SPD module 700 and an SPD unit 701 in circuits, applications and configurations as disclosed herein (e.g., in the circuits illustrated in FIGS. 7, 16 and 19-25).

The SPD unit 801 includes the SPD module 800, a first PCB assembly 860, and a second PCB assembly 870. The SPD module 800 forms an SPD module electrical circuit identical to the circuit 703 (FIG. 8) except that the switches of the signalization mechanisms are not included in the SPD module 800.

The SPD unit 801 and the SPD module 800 differ from the SPD unit 701 and the SPD module 700 in that the SPD unit 801 includes a first signalization mechanism R1A and a second signalization mechanism R2A in place of the first signalization mechanism R1 and the second signalization mechanism R2, respectively.

The first signalization mechanism RIA includes a first electrical switch 852 and an actuation feature or prong (on first barrier member) 835A. The switch 852 includes actuation contact 852A and electrical leads 852B. Likewise, the second signalization mechanism R2A includes a second electrical switch 854 and an actuation feature or prong (on first barrier member) 845A. The switch 854 includes actuation contact 854A and electrical leads 854B. The switches 852, 854 are external of the module housing 802 and may be directly mounted on and affixed to the PCB 874.

The module housing 802 has openings 802D through which the prongs 835B, 845B project when the corresponding thermal disconnect mechanism TDIA or TD2A is actuated. In this way, the released barrier members 835, 845 will actuate their associated switches 852 and 854 in same manner as described for the SPD module 700. The prongs 835B, 845B of the actuated thermal disconnect mechanisms TDIA or TD2A can also provide a local visible indication.

The SPD unit 801 and the SPD module 800 may be preferred over the SPD unit 701 and the SPD module 700 in some cases because the leads 852B, 854B of the switches 852, 854 can be more easily connected (e.g., by soldering) to the PCB 874 before assembling the SPD module 800 to the PCB 874.

The SPD module 800 and the PCB 874 also include cooperating locator features 802E, 874E. For example, as shown on FIG. 17, the locator features may include locator projections 802E forming a part of the SPD module 800 (e.g., molded features of the housing 802) and openings 874E in the PCB 874. The locator features 802E, 874E can ensure proper alignment between the prongs 852B, 854B and the switches 852, 854.

The thermal disconnector mechanisms TD1, TD2, TDIA, TD2A shown and described in the figures may be referred to as guillotine thermal disconnectors. Other types of thermal disconnectors may be provided in place of these guillotine thermal disconnectors in accordance with other embodiments.

### Further Definitions and Embodiments

In the above-description of various embodiments of the present inventive concept, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The terminology used herein is for the purpose of describing particular aspects only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

As used herein, “monolithic” means an object that is a single, unitary piece formed or composed of a material without joints or seams. Alternatively, a unitary object can be a composition composed of multiple parts or components secured together at joints or seams.

As used herein, the term “wafer” means a substrate having a thickness which is relatively small compared to its diameter, length or width dimensions.

The description of the present inventive concept has been presented for purposes of illustration and description, but is not intended to be exhaustive or limited to the inventive concept in the form disclosed. Many modifications and variations will be apparent to those of ordinary skill in the art without departing from the scope and spirit of the inventive concept. The aspects of the inventive concept herein were chosen and described to best explain the principles of the inventive concept and the practical application, and to enable others of ordinary skill in the art to understand the inventive concept with various modifications as are suited to the particular use contemplated.

What is claimed is:

1. A surge protective device (SPD) module comprising:
first, second and third terminals;
a node connected to the third terminal;
a varistor stack assembly including:
a first varistor;
a second varistor; and
a node electrode interposed between the first and second varistors;
wherein the node electrode is electrically connected to the first and second varistors and includes the node;
a first branch including:
the first varistor connected between the first terminal and the node; and
a first thermal disconnector mechanism configured to disconnect the first varistor from the first terminal or the node; and
a second branch including:
the second varistor connected between the second terminal and the node; and
a second thermal disconnector mechanism configured to disconnect the second varistor from the second terminal or the node.

2. The SPD module of claim 1 wherein:
the node electrode has opposed first and second varistor contact surfaces;
the first varistor contact surface engages the first varistor; and
the second varistor contact surface engages the second varistor.

3. The SPD module of claim 1 wherein:
the first thermal disconnector mechanism includes:
a first disconnect arm electrically connected to the first varistor; and
a spring-loaded, electrically insulating first barrier member configured to electrically isolate the first disconnect arm from the first varistor when the first thermal disconnector mechanism is actuated; and
the second thermal disconnector mechanism includes:
a second disconnect arm electrically connected to the second varistor; and
a spring-loaded, electrically insulating second barrier member configured to electrically isolate the second disconnect arm from the second varistor when the second thermal disconnector mechanism is actuated.

4. The SPD module of claim 3 wherein:
the first thermal disconnector mechanism includes a first solder connection including a first solder that retains the first disconnect arm in electrical connection with the first varistor;
when the first solder melts and releases the first disconnect arm, the first barrier member is thereby permitted to move from a ready position to a disconnect position in which the first barrier member electrically isolates the first disconnect arm from the first varistor;
the second thermal disconnector mechanism includes a second solder connection including a second solder that retains the second disconnect arm in electrical connection with the second varistor; and
when the second solder melts and releases the second disconnect arm, the second barrier member is thereby permitted to move from a ready position to a disconnect position in which the second barrier member electrically isolates the second disconnect arm from the second varistor.

5. The SPD module of claim 4 wherein:
the varistor stack assembly further includes:
a first contact electrode on a side of the first varistor opposite the node electrode; and
a second contact electrode on a side of the second varistor opposite the node electrode;
the first solder releasably affixes the first disconnect arm to the first contact electrode; and
the second solder releasably affixes the second disconnect arm to the second contact electrode.

6. The SPD module of claim 3 wherein:
the SPD module includes an integral first signalization switch to indicate failure of the first varistor;
the first thermal disconnector mechanism is configured such that the first barrier member actuates the first signalization switch when the first thermal disconnector mechanism is actuated;
the SPD module includes an integral second signalization switch to indicate failure of the second varistor; and
the second thermal disconnector mechanism is configured such that the second barrier member actuates the second signalization switch when the second thermal disconnector mechanism is actuated.

7. The SPD module of claim 3 wherein:
the SPD module includes an integral first signalization switch to indicate failure of the first varistor;
the SPD module includes an integral second signalization switch to indicate failure of the second varistor;
the first thermal disconnector mechanism is configured to actuate an external first signalization switch using the first barrier member when the first thermal disconnector mechanism is actuated; and
the second thermal disconnector mechanism is configured to actuate an external second signalization switch using the second barrier member when the second thermal disconnector mechanism is actuated.

8. A surge protective device (SPD) unit comprising:
a printed circuit board (PCB) assembly including a PCB including PCB contacts; and
an SPD module mounted on the PCB and including:
first, second and third terminals electrically engaging the PCB contacts to connect the SPD module to the PCB assembly;
a node connected to the third terminal;
a varistor stack assembly including:
a first varistor;
a second varistor; and
a node electrode interposed between the first and second varistors;
wherein the node electrode is electrically connected to the first and second varistors and includes the node;
a first branch including:
the first varistor connected between the first terminal and the node; and
a first thermal disconnector mechanism configured to disconnect the first varistor from the first terminal or the node; and
a second branch including:
the second varistor connected between the second terminal and the node; and
a second thermal disconnector mechanism configured to disconnect the second varistor from the second terminal or the node.

9. A surge protective device (SPD) module comprising:
a varistor stack assembly including a first varistor and a second varistor electrically connected to a first terminal and a second terminal, respectively, the first varistor and second varistor being further electrically connected to each other at a third terminal, the first varistor and the second varistor having electrical characteristics that reduce an imbalance in current between the first varistor and the second varistor in response to an overvoltage event;
wherein the first, second, and third terminals are configured to electrically connect the varistor stack assembly between one or more pairs of a plurality of lines.

10. The SPD module of claim 9, wherein the plurality of lines includes a plurality of power lines and a ground line;
wherein the first and second terminals are electrically connected to each other to form a common terminal; and
wherein the common terminal and the third terminal are configured to electrically connect the varistor stack assembly between one of the plurality of power lines and the ground line.

11. The SPD module of claim 9, wherein the plurality of lines includes a plurality of power lines and a neutral line;
wherein the first and second terminals are electrically connected to each other to form a common terminal; and
wherein the common terminal and the third terminal are configured to electrically connect the varistor stack assembly between one of the plurality of power lines and the neutral line.

12. The SPD module of claim 9, wherein the plurality of lines includes a plurality of power lines, a ground line, and a neutral line; and
wherein the third terminal is configured to electrically connect the first and second varistors to one of the plurality of power lines, the first terminal is configured to electrically connect the first varistor to the neutral line, and the second terminal is configured to electrically connect the second varistor to the ground line.

13. The SPD module of claim 9, wherein the plurality of lines includes a plurality of power lines; and
wherein the third terminal is configured to electrically connect the first and second varistors to a first one of the plurality of power lines, the first terminal is configured to electrically connect the first varistor to a second one of the plurality of power lines, and the second terminal is configured to electrically connect the second varistor to a third one of the plurality of power lines.

14. The SPD module of claim 9, wherein the plurality of lines includes a plurality of power lines and a ground line; and
wherein the third terminal is configured to electrically connect the first and second varistors to a first one of the plurality of power lines, the first terminal is configured to electrically connect the first varistor to a second one of the plurality of power lines, and the second terminal is configured to electrically connect the second varistor to the ground line.

15. The SPD module of claim 9, wherein the plurality of lines includes a plurality of power lines and a neutral line; and
wherein the third terminal is configured to electrically connect the first and second varistors to a first one of the plurality of power lines, the first terminal is configured to electrically connect the first varistor to a second one of the plurality of power lines, and the second terminal is configured to electrically connect the second varistor to the neutral line.

16. The SPD module of claim 9, wherein the plurality of lines include a plurality of power lines; and
wherein the plurality of power lines include power lines in a single phase power system or phase lines in a multiple phase power system.

17. The SPD module of claim 9, wherein the first varistor has a different clamping voltage than the second varistor;
wherein the first varistor has a different thickness than the second varistor;
wherein the first varistor has a different material composition than the second varistor;
wherein the first varistor has a different grain size than the second varistor; or
wherein the first varistor has a different grain size than the second varistor.
